(19) United States
(12) Patent Application Publication
(10) Pub. No.: US 2022/0055190 A1
(43) Pub. Date: Feb. 24, 2022

(54) Combination Pipe and Spud Wrench

(71) Applicant: Robert Gerrow, Minnedosa (CA)

(72) Inventor: Robert Gerrow, Minnedosa (CA)

(21) Appl. No.: 17/243,052

(22) Filed: Apr. 28, 2021

Related U.S. Application Data
(60) Provisional application No. 63/125,696, filed on Dec. 15, 2020.

(51) Int. Cl. B25B 13/50; B25B 13/16

(52) U.S. Cl. CPC B25B 13/5058; B25B 13/16

(57) ABSTRACT

A combination pipe and spud wrench features a main body having an elongated shank, and a shoulder jutting laterally outward from the shank at a distal portion thereof. A channel passes axially through the shoulder, a distal face of which has flat and serrated jaws on opposing sides of the channel. A working body has a stem passing axially through the channel, a second flat jaw facing the shoulder's flat jaw on a first side of the stem, and a second serrated jaw facing the shoulder's serrated jaw on a second side of the stem. An adjustment nut threaded on the stem is axially constrained position, and is rotatable to displace the working body and thereby adjustably resize the flat-sided and serrated jaw spaces. The stem is biased in a default position placing flat jaws parallel to one another, and is tiltable in one direction from its default position.

### CROSS-REFERENCE TO RELATED APPLICATIONS

This application claims benefit under 35 U.S.C. 119(e) of U.S. Provisional Patent Application No. 63/125,696, filed Dec. 15, 2020, the entirety of which is incorporated herein by reference.

### FIELD OF THE INVENTION

The present invention relates generally to hand tools, and more particularly to a multi-purpose wrench capable of being used as both a pipe wrench with serrated jaws for manipulating round pipe, and a spud wrench with flat-faced jaws for manipulating flat-sided fasteners.

### BACKGROUND

In the prior art, it has been known to design multi-purpose tools that are capable of performing different functions that previously relied on two or more separate and independent tools, thus reducing the total number of tools required to perform different work tasks, and thereby reducing the quantity and weight of tools that a worker must carry to a given jobsite, especially when the full scope of necessary work at such site is not known prior to arrival. Among such multi-purpose tools, there have previously been disclosed different examples of combination wrenches that either provide both a flat-sided jaw space for use on flat-sided nut and bolt fasteners and a serrated jaw space for use on round pipes, or instead provide interchangeable jaw pieces of flat-faced and serrated configuration by which the singular tool can be switched between a flat-sided jaw setup and a serrated jaw setup depending on whether the user is working with flat-sided fasteners or round pipe.

Despite prior attempts to address this issue, there does not appear to have been a commercially viable option, or at least not one that has sustained long a term commercial presence, as evidenced by the relatively antique nature of the majority of prior art known to the Applicant.

Accordingly, there remains a need for better design of a combination wrench that can effectively be used on both round pipe and flat-sided fasteners

### SUMMARY OF THE INVENTION

According to one aspect of the invention, there is provided a combination pipe and spud wrench comprising:

a main body comprising an elongated shank having opposing proximal and distal ends spaced from one another in an axial direction, and a shoulder jutting laterally outward from said elongated shank on a first side of said elongated shank at a distal portion thereof adjacent the distal end;

a channel passing through said shoulder in said axial direction on said first side of the elongated shank;

a first flat jaw situated on a distal face of the shoulder at a position situated across the channel from the elongated shank;

a first serrated jaw situated on the distal end of the elongated shank and across the channel from the first flat jaw;

a working body movably supported on the main body, and comprising:
a stem passing axially through the channel;
a second flat jaw carried on a first side of said stem in a position of opposing and facing relation to the first flat jaw, thereby delimiting a flat-sided jaw space therebetween; and
a second serrated jaw carried on an opposing second side of said stem in a position of opposing and facing relation to the first serrated jaw, thereby delimiting a serrated jaw space therebetween; and

an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces.

According to another aspect of the invention, there is provided a combination pipe and spud wrench comprising:

a main body comprising a shank of elongated shape in an axial direction for use of a proximal portion of said shank as an operating handle of said wrench;

a channel extending axially through a distal portion of said main body that resides distally of said proximal portion;

a first flat jaw residing in distally facing orientation on the distal portion of the main body on a first side of said channel;

a first serrated jaw residing in distally facing orientation on the distal portion of the main body on an opposing second side of said channel;

a working body movably supported on the main body, and comprising:
a stem passing axially through the channel;
a second flat jaw carried by said stem on a first side thereof in a proximally facing position of aligned and opposing relation to the first flat jaw, thereby delimiting a flat-sided jaw space therebetween; and
a second serrated jaw carried by said stem on an opposing second side thereof in a proximally facing position of aligned and opposing relation to the first serrated jaw, thereby delimiting a serrated jaw space therebetween; and

an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces;

wherein the stem of the working body is biased into a default position from which said stem is laterally tiltable relative to the elongated shank, and is further characterized in that (a) the first and second flat jaws reside in parallel relationship with one another in said default position; and/or (b) the working body is tiltable out of said default position in only one direction, specifically in a direction operable to widen a mouth of the serrated jaw space.

According to yet another aspect of the invention, there is provided a combination pipe and spud wrench comprising:

a main body comprising a shank of elongated shape in an axial direction for use of a proximal portion of said shank as an operating handle of said wrench;

a channel extending axially through a distal portion of said main body that resides distally of said proximal portion;

a first flat jaw residing in distally facing orientation on the distal portion of the main body on a first side of said channel;

a first serrated jaw residing in distally facing orientation on the distal portion of the main body on an opposing second side of said channel;

a working body movably supported on the main body, and comprising:
a stem passing axially through the channel;
a second flat jaw carried by said stem on a first side thereof in a proximally facing position of aligned and opposing relation to the first flat jaw, thereby delimiting a flat-sided jaw space therebetween; and
a second serrated jaw carried by said stem on an opposing second side thereof in a proximally facing position of aligned and opposing relation to the first serrated jaw, thereby delimiting a serrated jaw space therebetween; and

an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces;

wherein the stem of the working body is laterally tiltable relative to the elongated shank, a side of the channel nearest to the flat-sided jaw space has a flat wall segment that lies parallel to the axial direction and a sloped wall segment that spans therefrom toward the first flat jaw at an angle that widens said channel toward said first jaw, and the stem of the working body is biased into a default position in which one side of the stem abuts against said flat wall segment of the side of the channel nearest to the flat-sided jaw space.

### BRIEF DESCRIPTION OF THE DRAWINGS

One embodiment of the invention will now be described in conjunction with the accompanying drawings in which:

FIG. 1 is a front perspective view of a combination pipe and spud wrench of the present invention with a movable working body thereof in a default non-tilted position.

FIG. 2 is a front elevational view of the wrench of FIG. 1.

FIG. 3 is a side elevational view of the wrench of FIG. 1.

FIG. 4 is a cross-sectional view of the wrench of FIG. 3 as viewed along line A-A thereof.

FIG. 5 is another side elevational view of the wrench of FIG. 3, but with the working body moved into a tilted position.

FIG. 6 is a cross-sectional view of the wrench of FIG. 5 as viewed along line C-C thereof.

FIG. 7 is an isolated view of a main body of the wrench, cross-sectioned in the same plane as FIGS. 4 and 6.

FIG. 8 is an exploded perspective view of the wrench.

### DETAILED DESCRIPTION

Shown in the drawings is a combination pipe and spud wrench 10 featuring a flat-sided adjustable jaw space 12 on a first side of the tool, for use in rotational working of flat-sided fasteners (e.g. hexagonal nuts and bolt heads) in similar manner to a convention spud wrench, and with a serrated adjustable jaw space 14 on an opposing second side of the tool, for use in rotational working of round pipes in similar manner to a conventional pipe wrench. The tool is substantially composed of a main body 16 that is held in the user's hand to manipulate the tool, and a cooperative working body 18 that is movably supported on the main body in a manner operable to adjust the size of the two jaw spaces 12, 14 of the tool to fit differently sized fasteners and pipes. The main body 16 features an elongated shank 22 having a proximal end 22A, and an opposing distal end 22B lying oppositely and distally thereof in an axial direction denoted by a longitudinal axis 24 of the shank 22 that lies centrally thereof in a midplane PM of the shank that cuts therethrough from a front of the wrench to an opposing rear thereof. This axis 24, and the axial direction denoted thereby, are used as a reference to describe relative locations of various additional components and features of the tool.

In addition to the shank 22, the main body 16 also features a shoulder 20 that projects laterally outward from the shank on a first side 26 thereof, specifically at a distal portion 28 of the shank that neighbours the distal end 22B thereof. A remaining proximal portion 30 of the shank extends axially from the shoulder-equipped distal portion 28 to the proximal end 22A of the tool, whereby this proximal portion 30 of the shank 22 defines a manually graspable handle of the tool. As shown, a structural shape of the shank 22 may be of an I-beam configuration, at least over the span of the handle-defining proximal portion 30, to impart notable bending strength to the handle. At the distal end 22B, the shank 22 terminates in a plane lying transversely of the longitudinal axis 24, and in the illustrated example, in an end plane PE lying obliquely transverse of the shank midplane PM at an acute angle α thereto. Here, at the distal end 22B of the shank 22, is a first serrated jaw 32 whose serrated surface 32A faces axially and distally outward from the shank 22. In the non-limiting example of the illustrated embodiment, the first serrated jaw 32 is embodied by a separate jaw body attached to the main body by a cross-pin 34 that is engaged in aligned cross-bores of the main tool body and a base of the serrated jaw body. The serrated surface 32A of the jaw resides at the same acute angle α to the midplane PM and longitudinal axis 24 as the distal shank end 22B to which the serrated jaw is attached.

An outer periphery of the shoulder 20 of the main body 16 features a proximal face 36 that juts outward from the first side 26 of the shank 22 in a plane lying perpendicular to the midplane PM and longitudinal axis 24, and faces axially toward the proximal end 22A of the shank 22; and an angled outer face 38 whose plane obliquely intersects that of the proximal face 36 at an outer end thereof furthest from the shank 22, thereby forming a proximal outer corner 39 of the shoulder 20 from which the angled outer face 38 extends obliquely from the proximal face 36 in a distal direction away from the proximal end 22A of the shank. A distal face 40 of the shoulder's outer periphery resides oppositely of the proximal face 36 thereof, and spans inwardly back toward the shank 22, where this distal face 40 of the shoulder 20 then joins up with the distal end 22B of the shank 22. At a laterally outermost extent of the shoulder's periphery situated furthest from the shank 22, an outermost face 42 of the shoulder's periphery joins together the angled outer face 38 and the distal face 40, and in doing so, intersects the distal face 40 at a right angle to form a distal outer corner 44 of the shoulder 20. A flat outer region 40A of the distal face 40 that neighbours this distal outer corner 44 resides in parallel relation to the proximal face 36 of the shoulder, and thus in perpendicular relation to the shank midplane PM and longitudinal shank axis 24.

This flat outer region 40A, at least in the illustrated example, is a solid surface that defines a first flat jaw of the flat-sided jaw space 12, though a discrete jaw member formed separately of the main tool body 16 may alternatively be affixed to the shoulder's distal face 40 at the outer region thereof to instead define the first flat jaw. In the illustrated example, the shoulder's distal face 40 has a profiled shape that, from an inner end of the flat outer region 40A, has a step-shaped transition area 40B that transitions a short distance proximally back toward the proximal face 36, followed by an angled inner region 40C that that resides at an oblique angle to the shank midplane PM and thereby slopes distally back toward, and connects to, the distal end 22B of the shank.

The shoulder 20 is the portion of the main body by which the working body 18 is supported on the main body 16 of the tool. For such purposes, the shoulder 20 has a channel 46 passing fully therethrough in the axial direction from the distal face 40 of the shoulder 20 to the proximal face 36 thereof. The channel passes axially through the shoulder 20 at a location between the shank 22 and the first flat jaw 40A, and thus penetrates through the profiled distal face 40 of the shoulder 20 at the transitional and sloped areas 40B, 40C, thereof, while leaving the first flat jaw 40A and the first serrated wrench jaw 20 fully intact on opposing sides of the channel 46.

In cross-sectional planes lying normal to the longitudinal axis 24, the channel 46 is rectangular in shape, though the cross-sectional area of the channel is not-unform through the channel's length, and instead varies among said cross-sectional planes. This variation in channel width is attributable to profiled shapes in boundary walls of the channel at both an inner shank-adjacent side of the channel, and an outer shank-opposing side of the channel. The end of the channel that penetrates the distal face 40 of the shoulder 20 is referred to as a distal terminus of the channel 46, while the opposing end of the channel that penetrates the proximal face 36 of the shoulder is referred to as a proximal terminus of the channel 46.

Starting from the distal terminus of the channel 46, the inner shank-adjacent side of the channel 46 features a flat inner-wall segment 48A residing in a plane parallel to the shank midplane PM, followed by a neighbouring sloped inner-wall segment 48B that spans from the flat inner-wall segment 48A to the proximal terminus of the channel 46 at an angle lying obliquely of the flat inner-wall segment 48 and sloping inwardly of the shank 22 toward the midplane PM thereof. Starting from the proximal terminus of the channel 46, the outer shank-opposing side of the channel 46 features a flat outer-wall segment 50A residing in a plane parallel to the flat inner-wall segment 50B, followed by a neighbouring sloped outer-wall segment 50B that spans from the flat outer-wall segment 50A to the distal terminus of the channel 46 at an angle lying obliquely of the flat outer-wall segment 48 and sloping outwardly away from the shank 22 and the midplane PM thereof. The axial spans of the flat inner and outer wall segments 48A, 50A overlap one another at a mid-region of the channel 46, where the width of the channel is uniform and at its narrowest. Moving from this narrow mid-region of the channel in either axial direction toward the proximal face or distal face of the shoulder 20, the channel grows wider due to the orientation of the sloped wall segment on one side of the channel that angles away from the opposing flat wall segment on the other side of the channel.

The working body 18 has an overall T-shaped structure featuring an elongated stem 52 that lies alongside the shank 22 in a position passing fully through the channel 46 of the shoulder 20 and reaching axially past the distal end 22B of the shank 22. A double-sided head 54 of the working body 18 is affixed to the stem 52 in a position lying cross-wise thereto at a distal end thereof situated axially beyond the distal end 22B of the shank 22. A first side 54A of the working body head 54 projects laterally outward from the stem 52 at the same side thereof at which the first flat jaw 40A resides on the main body 16, while a second side 54B of the head 54 projects laterally outward from the stem 52 at the same side thereof at which the first serrated jaw 32 resides on the main body 16.

A proximally-facing edge of the first side 54A of the working body head 54 carries or defines a second flat jaw 56 of the tool. This second flat jaw 56 has a solid planar working surface that faces proximally toward the first flat jaw 40A on the main body 16 in opposing and aligned relation therewith, whereby the first and second flat jaws 40A, 56 cooperatively delimit the flat-sided jaw space 12 between them. An open mouth 12A of the flat-sided jaw space 12 is thus defined between the distal outer corner 44 of the main body's shoulder 20 at an outermost tip 58 of the first side 54A of the working body head 54. Accordingly, a hexagonal nut, hexagonal bolt head, or other flat-sided fastener is receivable into the flat-sided jaw space 12 through this open mouth 12A thereof. Meanwhile, an opposing closed end of the flat-sided jaw space 12 is defined by the working body stem 52, specifically at the area thereof that protrudes distally from the channel 46 in the shoulder 20 of the main body 16.

Similarly, a proximally-facing edge of the second side 54B of the working body head 54 carries or defines a second serrated jaw 60 of the tool, which features a serrated working surface that faces proximally toward the first serrated jaw 32 on the main body 16 in opposing and aligned relation therewith, whereby the first and second serrated jaws 32, 60 cooperatively delimit the serrated jaw space 14 between them. An open mouth 14A of the serrated jaw space 14 resides oppositely of a closed end thereof, the latter of which is once again defined by the working body stem 52, specifically at the area thereof that protrudes distally from the channel 46 in the shoulder 20 o the main body 16. Due at least partly to the above-described oblique angle of the first serrated jaw 32 on the distal end 22B of the shank 22, the first and second serrated jaws 32, 60 lie in divergent relation to one another, in a manner growing further apart from one another in a direction moving laterally outward from the working body stem 52 toward the open mouth 14A of the serrated jaw space 14.

A threaded proximal section of the working body stem 52 has external thread segments 62 thereon at opposing sides thereof, specifically at both a shank-adjacent side of the stem 52 and an opposing shank-opposing side thereof. These thread segments 62 start at a proximal end 52A of the stem, and span at least a partial fraction of the stem's overall length toward the working head 54 at the opposing distal end of the stem 52. An internally-threaded adjustment nut 64 closes around the threaded proximal section of the stem 52. The internal threading of the adjustment nut 64 is operably engaged with the thread segments 62 of the working body stem 52. The adjustment nut 64 preferably has a round and knurled outer circumference, and is rotatable around the working body stem 52, but is constrained from notable axial displacement relative to the main tool body shank 22.

To impose such axial constraint, the adjustment nut 64 is captured between the proximal face 36 of the shoulder 20, and a pair of stop lugs 66 that project laterally from the first side 26 of the main tool body shank 22 on opposing sides of the working body stem 52 at a distance spaced axially and proximally from the proximal face 36 of the shoulder 20. With the adjustment nut 64 axially constrained relative to the main tool body 16, manual rotation of the adjustment nut 64 causes displacement of working body stem 52 back and forth through the channel 46, whereby the adjustment nut 64 is operable to move the working body head 54 toward and away from the stationary jaws 40A, 32 on the main body 16, thereby adjusting the size of the flat-sided and serrated jaw spaces 14, 16 delimited between these stationary jaws 40A, 32 on the main body 16 and the movable jaws 56, 60 on the working body 18.

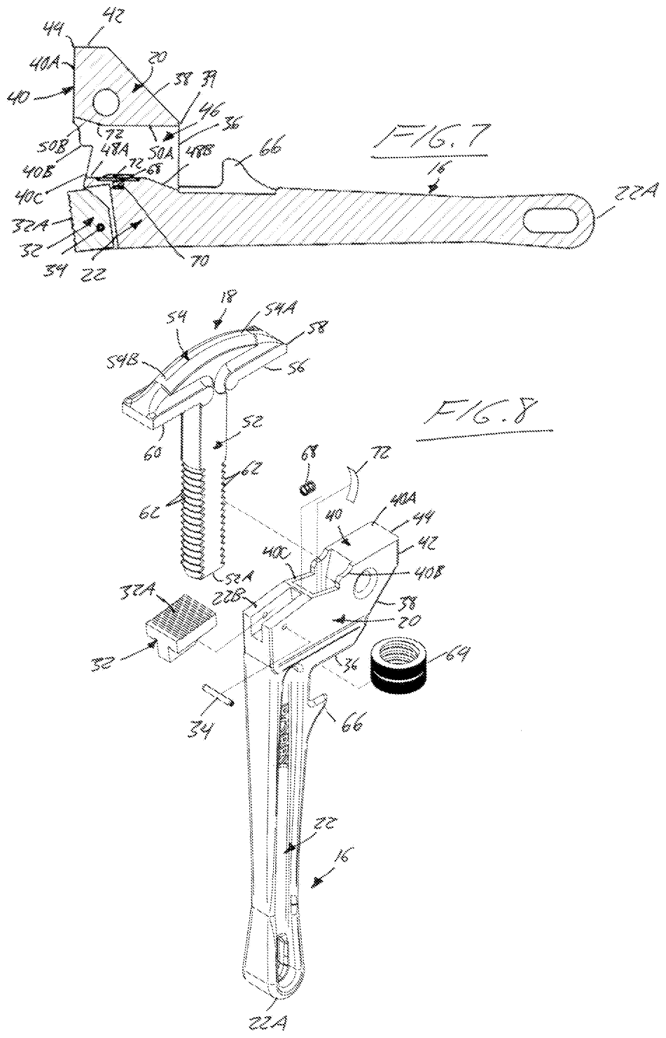

The minimum width of the channel 46 between the two flat wall segments 48A, 50A thereof exceeds a width of the mounting head stem 52, which allows some degree of tilting of the working body stem 52 within the channel 46, as can be seen by comparison of FIGS. 4 and 6. The working body stem 52 is normally biased into a default non-tilted position in which the working body stem 52 lies parallel to the longitudinal shank axis 24, and thus parallel to a similar longitudinal axis of the channel 46. The working body stem 52 is biased into this default position by a small compression spring 68 that has an inner end thereof seated within a receiving bore 70 in the flat wall segment 48A of the shank-adjacent side of the channel 46. From this bore 70, the spring 68 juts into the channel 46 to push against the shank-adjacent side of the working body stem 52, though in an indirect fashion via a resilient spring cover 72. Inside the channel 46, this spring cover 72 spans axially across an outer end of the spring 68 in arcuate fashion. The spring cover 72 is retained in such position by abutment of opposing ends of the spring cover 72 against opposing ends of a shallow recess in the flat inner-wall segment 48A that spans axially across the receiving bore 70.

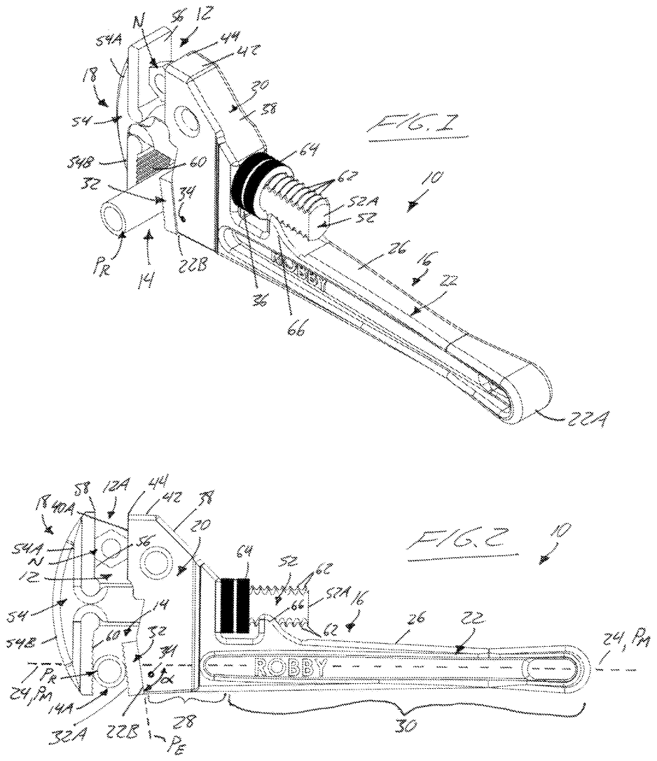

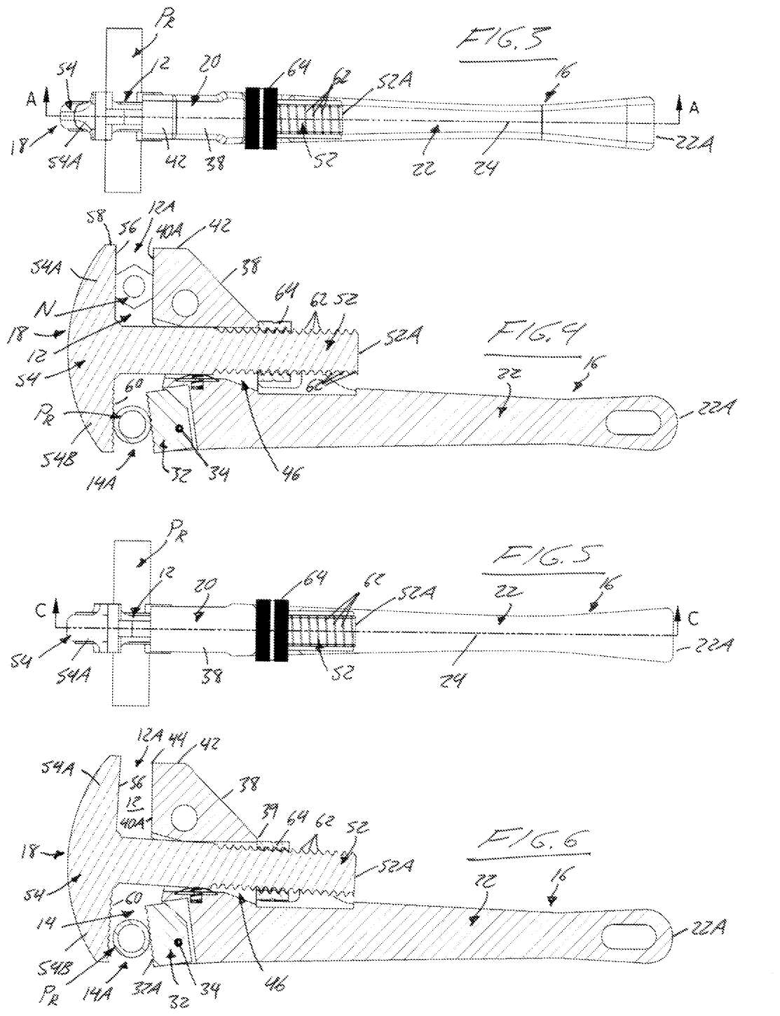

The location of the spring 68 on the flat inner-wall segment 48A of the shank-adjacent side of the channel 46 resides directly across the from the flat outer-wall segment 50A of the shank-opposing side of the channel 46. The shank-opposing side of the working body stem 52 is therefore spring biased into normally abutting contact against the flat outer-wall segment 50A of the shank-opposing side of the channel 46, as shown in Figure. The spring force thus normally holds the working body stem 52 in its default non-tilted position, absent exertion of any external forces exceeding the spring force. In this default non-tilted position of the working body 18, the first and second flat jaws 40A, 56 lie substantially parallel to one another, and are therefore respectively engagable against opposing flat sides of a flat-sided fastener, such the opposing flat sides of the hexagonal nut N shown in FIGS. 1, 2 and 4. Meanwhile, in the same default non-tilted position of the working body 18, the first and second serrated jaws 32, 60 are in a divergent relationship angling away from one another toward the open mouth 14A of the serrated jaw space 14. This way, with the serrated jaw space widest at its open mouth 14A thereof, a round pipe PR is more easily introduced into the serrated jaw space 14, and into a wedged position between the serrated jaws 32, 60.

When placing the wrench into working relation with the round pipe PR, the adjustment nut 64 is first used to adjust the open mouth 14A of the serrated jaw space 14 to a size slightly exceeding the diameter of the round pipe PR concerned, and the open mouth 14A is lowered over the pipe PR to introduce the pipe into the serrated jaw space 14. During introduction of the pipe PR through the open mouth 14A and into contact with the divergent serrated jaws 32, 60, initial contact of the pipe wall against the serrated jaws 32, 60 forces these two jaws 32, 60 further apart from one another, against the bias force of the spring 68, thus acting to both widen the serrated jaw space 14 and tilt the working body stem 52 out of it default position. Such tilting takes place about a fulcrum point 72 (FIG. 7) wherein the flat outer-wall segment 50A of the shank-opposing side of the channel 46 meets the sloped outer-wall segment 50B thereof. This tilting action takes place in a direction urging the proximal end 52A of the working body stem 52 toward the main body shank 22. The allowable amount of tilt is limited by eventual contact of one or both sides of the working body stem 52 with the sloped wall segment(s) on one or both sides of the channel 46, or by contact of the proximal end 52A of the working body stem 52 with the first side 26 of the main tool body shank 22. Accordingly, once the tilting action of the working body 18 is ceased by such contact between the body stem 52 and one or more non-fulcrum points on the main tool body, further widening of the serrated jaw space 14 by the admitted pipe is prevented, and any further advancement of the pipe PR into the serrated jaw space 14 now serves solely to wedge the pipe PR firmly between the two serrated jaws 32, 60, whereby their serrated surfaces frictionally bite against the pipe wall at opposing sides thereof.

The wrench is now ready to drive rotation of the pipe PR via exertion of manual force on the proximal handle portion 30 of the shank 22 from the shoulder-equipped first side 26 of the shank. Forced movement of the wrench in this direction is referred to herein as a working stroke of the wrench. This moment direction of this exerted manual force on the proximal handle portion 30 of the shank 22 is of opposite relation to the previous tilting action induced on the working body 18 by the wrench's prior placement on the pipe. The exerted manual force of the working stroke therefore acts in a manner attempting to return the working body 18 and main tool body 16 to their normal default relationship where the main body shank 22 and the working body stem 52 are parallel to one another. The manual force of the working stroke therefore attempts to drive the serrated jaws 32, 60 back toward one another, and thereby tightens the wrench's serrated frictional grip on the pipe while the wrench is being pushed or pulled through its working stroke from the shoulder-equipped side 26 of the shank 22. A reverse stroke performed by application of manual force in the opposing direction from the other side of the shank reduces the wrench's frictional bite on the pipe PR. Manual depression of the proximal end 52A of the working body stem 52 toward the shank 22 can likewise be used to lessen the wrench's frictional bite on the pipe PR.

So for selective use of the wrench on a round pipe PR, the tiltability of the working body stem 52 in the channel 46 in one permissible direction from its default spring-biased state allows the serrated jaw space 14 to widen from its default width at the user-selected displacement position of the working body (as set by the adjustment nut 64) up to a permitted maximum jaw space width at this selected displacement position (as limited by eventual contact of the tilted working body stem 52 with a non-fulcrum point on the main tool body). Once the pipe is wedged between the forced-apart serrated jaws, performance of a manual working stroke of the wrench increases the frictional biting action on the pipe to confidently drive rotation of the pipe via said working stroke.

On the other hand, since the working body stem 52 abuts against the flat wall segment 50A of the shank-opposing outer side of the channel 46 in the stem's default position, tilting of the working body stem 52 in the opposite direction from this default position is prohibited. Accordingly, when the flat-sided jaw space 12 of the wrench is used on a nut, bolt or other flat-sided fastener, the only permissible direction of relative tilt between the working body 18 and the main body 16 is in a direction that would cause the two flat jaws 40A, 56 to tilt toward one another from their normally parallel state in the default working body position. Accordingly, the only possible direction of relative movement between the flat-sided jaws 40A, 56 during use of the wrench on a flat-sided fastener is a movement direction that serves to increase the applied squeezing force on the fastener. Relative movement of the working body in an opposing direction causing the flat jaws 40A, 56 to tilt further apart from their default parallel relationship is prohibited.

Since various modifications can be made in my invention as herein above described, and many apparently widely different embodiments of same made, it is intended that all matter contained in the accompanying specification shall be interpreted as illustrative only and not in a limiting sense.

1. A combination pipe and spud wrench comprising:
a main body comprising an elongated shank having opposing proximal and distal ends spaced from one another in an axial direction, and a shoulder jutting laterally outward from said elongated shank on a first side of said elongated shank at a distal portion thereof adjacent the distal end;
a channel passing through said shoulder in said axial direction on said first side of the elongated shank;
a first flat jaw situated on a distal face of the shoulder at a position situated across the channel from the elongated shank;
a first serrated jaw situated on the distal end of the elongated shank and across the channel from the first flat jaw;
a working body movably supported on the main body, and comprising:
a stem passing axially through the channel;
a second flat jaw carried on a first side of said stem in a position of opposing and facing relation to the first flat jaw, thereby delimiting a flat-sided jaw space therebetween; and
a second serrated jaw carried on an opposing second side of said stem in a position of opposing and facing relation to the first serrated jaw, thereby delimiting a serrated jaw space therebetween; and
an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces.

2. The wrench of claim 1 wherein the stem of the working body is laterally tiltable relative to the elongated shank, and is biased into a default position placing the first and second flat jaws in parallel relationship with one another.

3. The wrench of claim 1 wherein the stem of the working body is biased into a default position, and is tiltable out of said default position in only one direction, and tilting of said working body in said one direction is operable to widen a mouth of the serrated jaw space.

4. The wrench of claim 2 wherein said default position of the working body places the first and second serrated jaws in divergent relationship to one another, in a manner growing further apart in a lateral direction moving away from the stem.

5. The wrench of claim 2 wherein the stem of the working body is biased into said default position by a spring operably disposed between the main body and the stem of the working body at a shank-adjacent side of the channel.

6. The wrench of claim 5 wherein said shank-adjacent side of the channel, at an area thereof disposed between the spring and a proximal terminus of the channel, comprises a sloped shank-adjacent wall segment that is obliquely oriented relative to the axial direction, and that slopes inwardly of the elongated shank in a direction moving axially toward said proximal terminus of the channel.

7. The wrench of claim 1 wherein a shank-adjacent side of the channel, at an area thereof approaching a proximal terminus of the channel, comprises a sloped shank-adjacent wall segment that is obliquely oriented relative to the axial direction, and that slopes inwardly of the elongated shank in a direction moving axially toward said proximal terminus of the channel.

8. The wrench of claim 1 wherein a shank-opposing side of the channel has a flat shank-opposing wall segment that lies parallel to the axial direction, and against which a shank-opposing outer side of the stem is normally biased.

9. The wrench of claim 8 wherein said shank-opposing side of the channel, at an area thereof between the flat shank-opposing wall segment and the distal face of the shoulder, has a sloped shank-opposing wall segment that is of obliquely oriented relationship to the axial direction, and that slopes outwardly away from the elongated shank in a direction moving axially toward the distal face of the shoulder.

10. The wrench of claim 1 wherein a shank-opposing side of the channel has, at an area thereof approaching the distal face of the shoulder, has a sloped shank-opposing wall segment that is of obliquely oriented relationship to the axial direction, and that slopes outwardly away from the elongated shank in a direction moving axially toward the distal face of the shoulder.

11. A combination pipe and spud wrench comprising:
a main body comprising a shank of elongated shape in an axial direction for use of a proximal portion of said shank as an operating handle of said wrench;
a channel extending axially through a distal portion of said main body that resides distally of said proximal portion;
a first flat jaw residing in distally facing orientation on the distal portion of the main body on a first side of said channel;
a first serrated jaw residing in distally facing orientation on the distal portion of the main body on an opposing second side of said channel;
a working body movably supported on the main body, and comprising:
a stem passing axially through the channel;
a second flat jaw carried by said stem on a first side thereof in a proximally facing position of aligned and opposing relation to the first flat jaw, thereby delimiting a flat-sided jaw space therebetween; and
a second serrated jaw carried by said stem on an opposing second side thereof in a proximally facing position of aligned and opposing relation to the first serrated jaw, thereby delimiting a serrated jaw space therebetween; and
an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces;
wherein the stem of the working body is biased into a default position from which said stem is laterally tiltable relative to the elongated shank, and is further characterized in that (a) the first and second flat jaws reside in parallel relationship with one another in said default position; and/or (b) the working body is tiltable out of said default position in only one direction, specifically in a direction operable to widen a mouth of the serrated jaw space.

12. The wrench of claim 11 wherein said default position of the working body places the first and second serrated jaws in divergent relationship to one another, in a manner growing further apart in a lateral direction moving toward said mouth of the serrated jaw space.

13. The wrench of claim 11 wherein the stem of the working body is biased into said default position by a spring operably disposed between the main body and the stem of the working body at side of the channel nearest to the serrated jaw space.

14. The wrench of claim 13 wherein said side of the channel, at an area thereof disposed between the spring and a proximal terminus of the channel, comprises a sloped wall segment that is obliquely sloped relative to the axial direction in a manner widening said channel toward the proximal terminus thereof.

15. The wrench of claim 11 wherein a side of the channel nearest to the serrated jaw space, at an area thereof approaching a proximal terminus of the channel, comprises a sloped shank-adjacent wall segment that is obliquely sloped relative to the axial direction in a manner widening said channel toward the proximal terminus thereof.

16. The wrench of claim 11 wherein a side of the channel nearest to the flat-sided jaw space has a flat wall segment that lies parallel to the axial direction, and against which one side of the stem is normally biased.

17. The wrench of claim 16 wherein said side of the channel nearest to the flat-sided jaw space, at an area between the flat wall segment thereof and the first flat jaw, has a sloped wall segment that is obliquely sloped relative to the axial direction in a manner widening the channel toward the first flat jaw.

18. The wrench of claim 11 wherein a side of the channel nearest to the flat-sided jaw space has, at an area thereof approaching the first flat jaw, has a sloped wall segment that is obliquely sloped relative to the axial direction in a manner widening the channel toward the first flat jaw.

19. A combination pipe and spud wrench comprising:
a main body comprising a shank of elongated shape in an axial direction for use of a proximal portion of said shank as an operating handle of said wrench;
a channel extending axially through a distal portion of said main body that resides distally of said proximal portion;
a first flat jaw residing in distally facing orientation on the distal portion of the main body on a first side of said channel;
a first serrated jaw residing in distally facing orientation on the distal portion of the main body on an opposing second side of said channel;
a working body movably supported on the main body, and comprising:
a stem passing axially through the channel;
a second flat jaw carried by said stem on a first side thereof in a proximally facing position of aligned and opposing relation to the first flat jaw, thereby delimiting a flat-sided jaw space therebetween; and
a second serrated jaw carried by said stem on an opposing second side thereof in a proximally facing position of aligned and opposing relation to the first serrated jaw, thereby delimiting a serrated jaw space therebetween; and
an adjustment nut threadingly engaged with the stem in a position of axially constrained relationship to the elongated shank such that rotation of the adjustment nut in opposing rotational directions is operable to displace the working body relative to the main body in opposing axial directions to thereby adjustably resize the flat-sided and serrated jaw spaces;
wherein the stem of the working body is laterally tiltable relative to the elongated shank, a side of the channel nearest to the flat-sided jaw space has a flat wall segment that lies parallel to the axial direction and a sloped wall segment that spans therefrom toward the first flat jaw at an angle that widens said channel toward said first jaw, and the stem of the working body is biased into a default position in which one side of the stem abuts against said flat wall segment of the side of the channel nearest to the flat-sided jaw space.

20. The wrench of claim 19 wherein a side of the channel nearest to the serrated jaw space, at an area thereof approaching a proximal terminus of the channel, comprises a sloped shank-adjacent wall segment that is obliquely sloped relative to the axial direction in a manner widening said channel toward the proximal terminus thereof.
